(19) United States
(12) Patent Application Publication
(10) Pub. No.: US 2015/0234153 A1
(43) Pub. Date: Aug. 20, 2015

(54) REFLECTIVE VARIFOCAL LENS AND IMAGING SYSTEM INCLUDING THE SAME

(71) Applicant: ELECTRONICS AND TELECOMMUNICATIONS RESEARCH INSTITUTE, Daejeon (KR)

(72) Inventors: Sun Tak PARK, Incheon (KR); Sung Ryul YUN, Daejeon (KR); Bong Je PARK, Daejeon (KR); Sae Kwang NAM, Daejeon (KR); Ki Uk KYUNG, Daejeon (KR)

(73) Assignee: ELECTRONICS AND TELECOMMUNICATIONS RESEARCH INSTITUTE, Daejeon (KR)

(21) Appl. No.: 14/618,282

(22) Filed: Feb. 10, 2015

(30) Foreign Application Priority Data
Feb. 18, 2014 (KR) 10-2014-0018684
Jan. 13, 2015 (KR) 10-2015-0006136

(51) Int. Cl. G02B 13/00; H04N 5/225; G02B 26/08; G02B 17/06; G02B 27/14

(52) U.S. Cl. CPC G02B 13/0075; G02B 13/0065; G02B 17/0694; G02B 27/14; G02B 26/0825; G02B 13/0015; H04N 5/2254

(57) ABSTRACT

Provided herein is a reflective varifocal lens configured to change a focal length using an electric signal, the lens including a first electrode layer having conductivity; an electric active polymer layer formed on the first electrode layer; a second electrode layer having conductivity formed on the electric active polymer layer; and a reflective layer configured to reflect a light entering towards the first electrode layer or second electrode layer, wherein a shape of the electric active polymer layer is changed by the electric signal being applied to the first electrode layer and second electrode layer, and as the shape of the electric active polymer layer changes, a shape of the reflective layer changes, thereby changing a focal length of a reflective light.

### CROSS-REFERENCE TO RELATED APPLICATION

The present application claims priority to Korean patent application numbers 10-2014-0018684 filed on Feb. 18, 2014 and 10-2015-0006136 filed on Jan. 13, 2015, the entire disclosure of which is incorporated herein in its entirety by reference

### BACKGROUND

1. Field of Invention

Various embodiments of the present disclosure relate to an optical system, and more particularly, to a reflective varifocal lens and an imaging system including the same.

2. Description of Related Art

Due to the recent development of display technologies such as cameras, mobile terminals, projectors, and TVs that have their bases on digital technologies, there is a demand for high-resolution screens and miniaturized optical systems related thereto. Furthermore, as there is a growing emphasis on miniaturization and convenience of an optical system to obtain high resolution images, researches thereon are being conducted proactively.

Especially, as camera modules mounted onto mobile terminals are provided with high resolution image sensors, the importance of functions such as varifocal functions and optical zoom functions and so forth is being emphasized even more. Currently, in order to embody a varifocal function and optical zoom function in a mobile camera module, actuators are most widely used. An automatic zoom actuator performs a function of bringing a lens into focus by adjusting a position of the lens using mostly a VCM (voice coil motor) method or piezo method. The VCM method is a method of using the current flowing through a coil and electromagnetic force by a magnetic, which method has limitations such as electromagnetic waves and limitations in the degree of precision, while the piezo method is a method of using the friction of a stator and rotator, which method has a short lifespan due to friction and is expensive. Furthermore, the optical zoom function is a method using a step motor, wherein a lead screw is rotated by a driver that makes rotational movement thereby linearly moving a mobile unit and thus has disadvantages of friction of the gear part and noise and so forth. As in the aforementioned examples, most of conventional technologies are difficult to produce due to their complex structures, and have limitations in miniaturizing their sizes.

Furthermore, most of conventional reflective varifocal lens technologies use pressures of gas or fluid, or electromagnetic force. Those technologies using pressures of gas or fluid need a pressure adjustment apparatus, and thus it is difficult to reduce the size or make them into arrays. Furthermore, due to their complex producing process and structure, the manufacturing costs are very high.

### SUMMARY

A purpose of various embodiments of the present disclosure is to provide a reflective varifocal lens using a variable material, the lens having a simple structure that may be miniaturized, and an imaging system including the same.

An embodiment of the present disclosure provides a reflective varifocal lens using a variable material, wherein a focal length may be changed by changing a radius curvature of the reflective lens.

Another embodiment of the present disclosure provides an image system including a reflective varifocal lens.

According to an embodiment of the present disclosure, there is provided a reflective varifocal lens configured to change a focal length using an electric signal, the lens including: a first electrode layer having conductivity; an electric active polymer layer formed on the first electrode layer; a second electrode layer having conductivity formed on the electric active polymer layer; and a reflective layer configured to reflect light entering towards the first electrode layer or second electrode layer, wherein a shape of the electric active polymer layer is changed by the electric signal being applied to the first electrode layer and second electrode layer, and as the shape of the electric active polymer layer changes, a shape of the reflective layer changes, thereby changing a focal length of a reflective light.

In the embodiment, the reflective layer may be formed on a lower surface of the first electrode layer or an upper surface of the second electrode layer.

In the embodiment, the reflective layer may be formed within the electric active polymer layer.

In the embodiment, at least one of the first electrode layer and second electrode layer, and the electric active polymer layer may be made of transparent material.

In the embodiment, the electric active polymer layer may include a first polymer layer and second polymer layer, and the reflective layer may be disposed between the first polymer layer and second polymer layer.

In the embodiment, the electric active polymer layer may include a ring-shaped first region and a circular-shaped second region inside the first region, the first electrode layer and second electrode layer may be ring-shaped, and may be formed on a lower surface and upper surface of the first region of the electric active polymer layer, and the reflective layer may be circular-shaped, and may be formed on an upper surface or lower surface of the second region of the electric active polymer layer.

In the embodiment, the electric active polymer layer may include a ring-shaped first region and a circular-shaped second region inside the first region, the first electrode layer and second electrode layer may be ring-shaped, and may be formed on a lower surface and upper surface of the first region of the electric active polymer layer, the reflective layer may be circular-shaped, and may be formed on the second region inside the electric active polymer layer, and the electric active polymer layer may be made of transparent material.

In the embodiment, the reflective layer may be formed by a plurality of reflective particle layers positioned inside the electric active polymer layer.

According to another embodiment of the present disclosure, there is provided a reflective varifocal lens including a first conductive layer having conductivity; an electric active polymer layer formed on the first electrode layer; and a second electrode layer having conductivity formed on the electric active polymer layer, wherein at least one of the first electrode layer and second electrode layer is configured to reflect light, a shape of the electric active polymer layer is changed by an electric signal being applied to the first electrode layer and second electrode layer, and as the shape of the electric active polymer layer changes, a shape of the at least one of the first electrode layer and second electrode layer configured to reflect light changes, thereby changing a focal length of a reflective light.

According to another embodiment of the present disclosure, there is provided an image system including an image sensor; and a reflective varifocal lens configured to reflect an entering light and allow the same to enter the image sensor, wherein the reflective varifocal lens includes a first electrode layer having conductivity; an electric active polymer layer formed on the first electrode layer; a second electrode layer having conductivity formed on the electric active polymer layer; and a reflective layer configured to reflect a light entering towards the first electrode layer or second electrode layer, and a shape of the electric active polymer layer is changed by an electric signal being applied to the first electrode layer and second electrode layer, and as a shape of the electric active polymer layer changes, a shape of the reflective layer changes, thereby changing a focal length of a reflective light entering the image sensor.

In the embodiment, the image system may further include a beam splitter, wherein the beam splitter is configured to allow a light entering the image system to penetrate the beam splitter and enter the reflective varifocal lens, and to change a proceeding direction of the light reflected from the reflective varifocal lens so that the reflective light enters the image sensor.

According to an embodiment of the present disclosure, it is possible to provide a reflective varifocal lens capable of changing a focal length by changing a radius curvature of a reflective lens using a variable material.

According to another embodiment of the present disclosure, it is possible to provide an image system including a reflective varifocal lens.

According to a reflective varifocal lens according to the various embodiments of the present disclosure and an imaging system including the same, it is possible to configure an electric active polymer of which its thickness may expand or contract when a voltage is applied, a support that restricts the expansion and contraction, and a reflective layer that reflects light into one film and form a reflective lens. The reflective varifocal lens according to various embodiments of the present disclosure does not use physical force or pressure but is driven electrically, and thus has a very simple structure that may be easily miniaturized or made into arrays. Furthermore, it has a wide range for changing the focus of the lens and enables changing the focus at very high speed.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a view illustrating a reflective varifocal lens where no voltage is applied according to an embodiment of the present disclosure.

FIG. 2 is a view illustrating a reflective varifocal lens where a voltage is applied according to an embodiment of the present disclosure.

FIG. 3 is a plane view of a reflective varifocal lens according to an embodiment of the present disclosure.

FIG. 4 is a cross-sectional view along path A-A′ of the reflective varifocal lens of FIG. 3 where no voltage is applied.

FIG. 5 is a cross-sectional view along path A-A′ of the reflective varifocal lens of FIG. 3 where a voltage is applied.

FIG. 6 is a cross-sectional view of a reflective varifocal lens according to another embodiment of the present disclosure.

FIG. 7 is a plane view of a reflective varifocal lens according to another embodiment of the present disclosure.

FIG. 8 is a cross-sectional view along path B-B′ of the reflective varifocal lens of FIG. 7.

FIG. 9 is a cross-sectional view of a reflective varifocal lens according to another embodiment of the present disclosure.

FIG. 10 is a cross-sectional view of a reflective varifocal lens according to another embodiment of the present disclosure.

FIG. 11 is a cross-sectional view of a reflective varifocal lens according to another embodiment of the present disclosure.

FIG. 12 is a view illustrating an imaging system according to another embodiment of the present disclosure.

FIG. 13 is a view illustrating an imaging system according to another embodiment of the present disclosure.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

In order to resolve the abovementioned problems, a reflective varifocal lens has a structure wherein a reflective lens is produced using a variable geometric material, that is, an electric active polymer, and a voltage is applied to both surfaces of the lens to change a shape of the electric active polymer, thereby changing a focal length of the lens. The structure of the reflective varifocal lens may include an electric active polymer film and an electrode of which both surfaces are coated with the film, a reflective layer, and a support capable of supporting the lens shape. The reflective varifocal lens is driven based on a principle where when a voltage is applied to both surfaces of the electrode coated with the electric active polymer film, the electric active polymer film expands in a horizontal direction, and the support plays a role of obstructing the expansion of the electric active polymer. Herein, the electric active polymer film expands convexly in a vertical direction of the film, and when a reflective layer is formed that is capable of reflecting light on a convex inner surface, the reflective layer becomes a reflective lens. Herein, the extent of the convex may be adjusted according to the voltage being applied, which is the principle of changing the focus of the reflective lens.

Hereinafter, desirable embodiments of the present disclosure are explained with reference to the attached drawings. Herein, it is to be noted that same components in the drawings are represented by the same reference numerals. In the explanation below, only the parts necessary for understanding the operations of the present disclosure are explained, and other parts are omitted so as not to obscure the main points of the present disclosure. Furthermore, the present disclosure may be embodied in other forms without limitations to the embodiments explained herein. The embodiments explained herein are provided to explain the present disclosure in detail to such an extent as to easily implement the technology concept of the present disclosure to those skilled in the art.

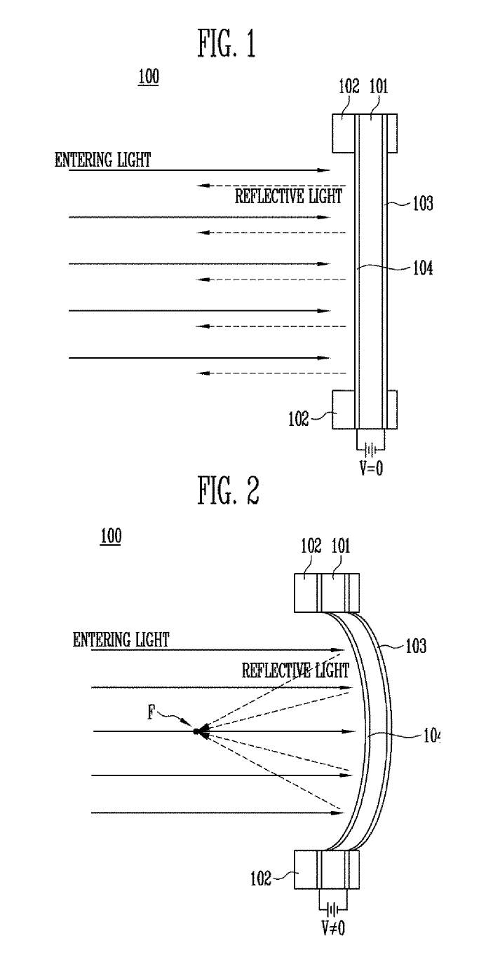

FIG. 1 is a view illustrating a reflective varifocal lens where no voltage is applied according to an embodiment of the present disclosure.

Referring to FIG. 1, a reflective varifocal lens according to an embodiment of the present disclosure 100 includes a first electrode layer 103 having conductivity, an electric active polymer layer 101 formed on the first electrode layer 103, and a second electrode layer 104 having conductivity formed on the electric active polymer layer 101. Although not illustrated in FIG. 1, the reflective varifocal lens according to the embodiment of the present disclosure 100 further includes a reflective light that reflects a light entering towards the first electrode layer 103 or second electrode layer 104.

The first electrode layer 103 and second electrode layer 104 may play a role of applying a voltage to the electric active polymer layer 101. The first electrode layer 103 and second electrode layer 104 may have different polarities from each other when operating. The first electrode layer 103 and second electrode layer 104 may be made of a flexible material so that their shapes may change in accordance with a change of shape of the electric active polymer layer 104 when applying the voltage. Not only silver nano wires, graphene, carbon nanotubes but also flexible metal and conductive polymer may be used for the first electrode layer 103 and second electrode layer 104. That is, the first electrode layer 103 and second electrode layer 104 may be made of any material having conductivity and flexibility.

The electric active polymer layer 101 may have a property of a thickness of its material changing when a voltage is applied, that is, a property of contracting or expanding in a direction vertical to a direction in which the voltage is applied. In the present disclosure, the electric active polymer is presented as a material of which the shape changes when a voltage is applied, but there is no limitation thereto, and thus various materials may be used instead of the electric active polymer layer 101 as long as their shapes change according to a voltage applied.

Furthermore, depending on the purpose of usage of the reflective varifocal lens, the electric active polymer film may be configured such that its thickness is not uniform but to have a certain portion that is is convex or concave at its initial state where no voltage is applied. For convenience of explanation in the entirety of the present specification, the reflective varifocal lens 100 is illustrated such that it has a flat shape and has a very distant focal length when no voltage is applied, whereas when a voltage is applied, its shape becomes convex and its focal length decreases. However, in some embodiments, the reflective varifocal lens may be configured to have a convex or concave shape when no voltage is applied, and as a certain voltage is applied, its entirety of shape becoming flat, thereby increasing the focal length.

The reflective layer (not illustrated) plays a role of reflecting a light entering the reflective varifocal lens 100 and emitting a reflective light, and the reflective layer may be made of a material such as metal or dielectric substance that are capable of reflecting light. Furthermore, the reflective layer (not illustrated) may be of various structures and be positioned in various locations as long as it may reflect light.

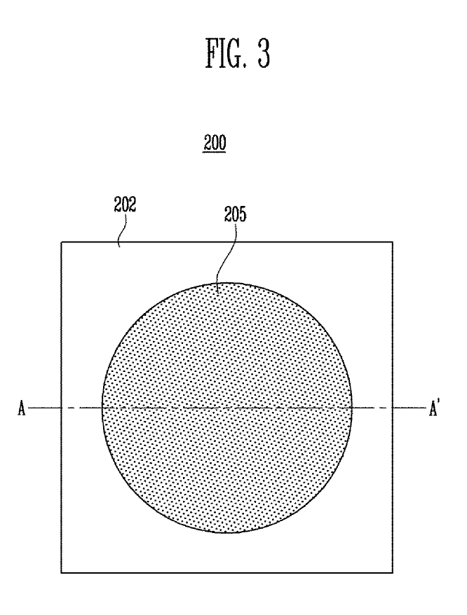

The reflective varifocal lens according to the embodiment of the present disclosure 100 may further include a support 102 that supports the electric active polymer layer 101. The support 102 may be positioned in the outskirts of the reflective varifocal lens 100. When a voltage is applied to the first electrode layer 103 and second electrode layer 104, the support 102 may play a role of obstructing an expansion of the electric active polymer layer 101 in accordance with its shape. Then, the electric active polymer layer 101 expands convexly in a direction vertical thereto. The situation where a voltage is applied to the first electrode layer 103 and second electrode layer 104 so as to change the shape of the reflective varifocal lens 100 will be explained hereinafter with reference to FIG. 2.

FIG. 2 is a view illustrating a reflective varifocal lens where a voltage is applied according to an embodiment of the present disclosure.

Referring to FIG. 2, the reflective varifocal lens 100 includes a first electrode layer 103, second electrode layer 104, electric active polymer layer 101 and support 102, similarly as in FIG. 1. When a voltage is applied to the first electrode layer 103 and second electrode layer 104, the electric active polymer layer 101 expands in a layer direction. Herein, the support 102 that supports the electric active polymer layer 101 obstructs an expansion of the electric active polymer layer 101 within a support region. Therefore, the electric active polymer layer 101 expands convexly in a direction vertical thereto within a region not supported by the support 102. A reflective layer (not illustrated) changes its shape as the electric active polymer layer 101 changes its shape, thereby changing a focus position (F). FIGS. 1 and 2 illustrate the reflective varifocal lens 100 wherein a focal length decreases when a voltage is applied. As aforementioned, when necessary, the reflective varifocal lens may be configured such that its focal length increases when a voltage is applied.

The extent of change of the electric active polymer payer 101 may be adjusted according to the voltage being applied. Therefore, the focal length of the reflective varifocal lens 100 may also be adjusted by changing the voltage being applied. That is, in the embodiment illustrated in FIG. 2, the greater the voltage being applied, the smaller the radius curvature of the reflective layer (not illustrated), thereby reducing the focal length. If the polarity of the voltage applied to the electrode is reversed, the electric active polymer layer changes its form in the opposite direction. Consequently, the reflective layer changes its form, bulging out or being convex in a direction the entering light. As a result, the focal length of the reflective varifocal lens will have a negative value, and the reflected light is not focused on one point but will likely spread out.

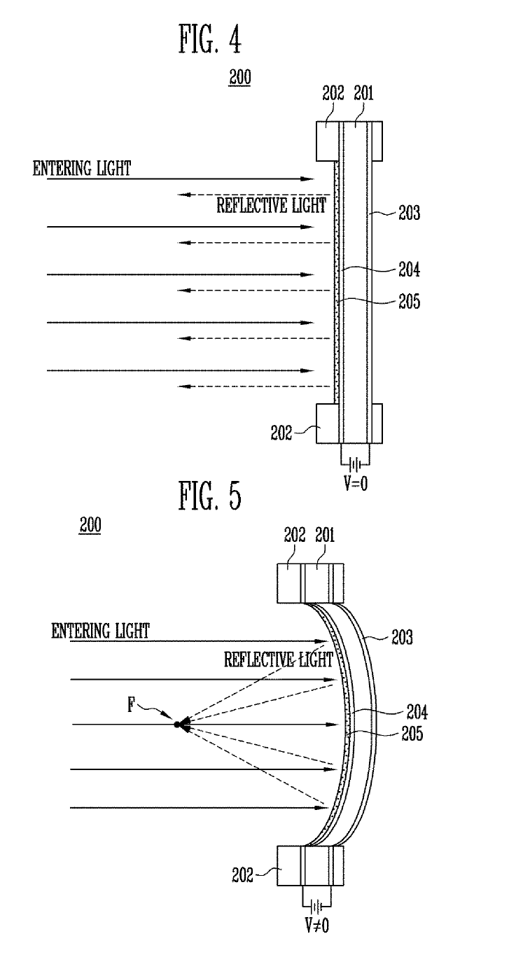

FIG. 3 is a plane view of a reflective varifocal lens according to an embodiment of the present disclosure, and FIG. 4 is a cross-sectional view along path A-A′ of the reflective varifocal lens of FIG. 3 where no voltage is applied.

Referring to FIGS. 3 and 4, a reflective varifocal lens according to an embodiment of the present disclosure 200 includes a first electrode layer 203 having conductivity, electric active polymer layer 201 formed on the first electrode layer 203, second electrode layer 204 having conductivity formed on the electric active polymer layer 201, and reflective layer 205 formed on the second electrode layer 204. The reflective layer 205 reflects a light entering towards the second electrode layer 204. The shape of the electric active polymer layer 201 is changed by an electric signal being applied to the first electrode layer 203 and second electrode layer 204, and as the shape of the electric active polymer layer 201 changes, the shape of the reflective layer 205 changes, thereby changing a focal length of a reflective light. FIG. 3 illustrates an embodiment wherein the reflective layer 205 is formed in the outskirts of the second electrode layer 204. As illustrated in FIG. 3, the reflective varifocal lens 200 includes the electric active polymer layer 201 made of a film, first electrode layer 203 and second electrode layer 204 coated on both surfaces of the electric active polymer layer 201, and reflective layer 205 coated on the second electrode layer 204. That is, the reflective varifocal lens 200 may be configured as one sheet of thin film.

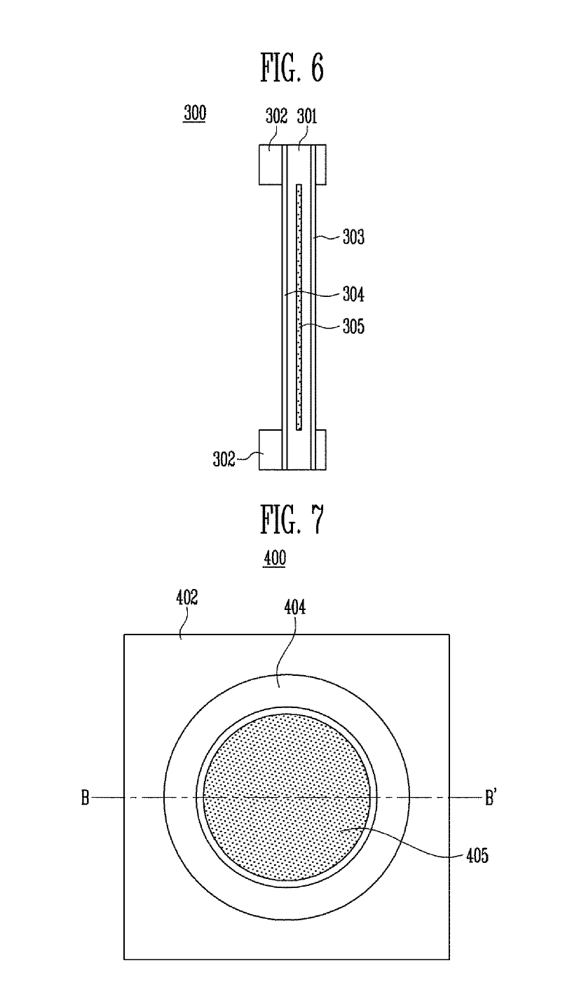

FIG. 5 is a cross-sectional view along path A-A′ of the reflective varifocal lens of FIG. 3 where a voltage is applied. Referring to FIG. 5, similarly as in FIG. 4, the reflective varifocal lens 200 includes the first electrode layer 203, second electrode layer 204, electric active polymer layer 201 and support 202. When a voltage is applied to the first electrode layer 203 and second electrode layer 204, the electric active polymer layer 201 expands in a layer direction. Herein, the support 202 that supports the electric active polymer layer 201 obstructs the expansion of the electric active polymer layer 201 within the support region. Therefore, in the region not supported by the support 202, the electric active polymer layer 201 expands convexly in a vertical direction thereto. The shape of the reflective layer 205 changes according to the change of shape of the electric active polymer layer 201, thereby changing a focal position (F). FIGS. 4 and 5 illustrate the reflective varifocal lens wherein a focal length decreases when a voltage is applied. As aforementioned, when necessary, the reflective varifocal lens may be configured such that its focal length increases when a voltage is applied.

The extent of change of the electric active polymer layer 201 may be adjusted according to the voltage being applied. Therefore, the focal length of the reflective varifocal lens 200 may also be adjusted by changing the voltage being applied. That is, in the embodiment illustrated in FIG. 5, the greater the voltage, the smaller the radius curvature of the reflective layer 205, thereby reducing the focal length.

FIG. 6 is a cross-sectional view of a reflective varifocal lens according to another embodiment of the present disclosure.

Referring to FIG. 6, a reflective varifocal lens according to another embodiment of the present disclosure 300 includes a first electrode layer 303 having conductivity, electric active polymer layer 301 formed on the first electrode layer 303, second electrode layer 304 having conductivity formed on the electric active polymer layer 301, and reflective layer 305 formed within the electric active polymer layer 301. Furthermore, the reflective varifocal lens 300 includes a support 302 that supports the electric active polymer layer 301. In the embodiment illustrated in FIG. 6, the reflective layer 305 is inserted inside the electric active polymer layer 301. The electric active polymer layer 301 plays a role of a protection layer during expansion and bending, thereby improving durability and minimizing the stress of the reflective layer 305 caused by the expansion and contraction.

When the reflective layer 305 is positioned inside the electric active polymer layer 301, at least one of the first electrode layer 303 and second electrode layer 304 must be made of a transparent material along a direction of the entering light, and the electric active polymer layer 301 must also be made of a transparent material. In the case of the embodiment illustrated in FIGS. 4 and 5, the reflective layer 205 is formed outside the electric active polymer layer 201 and second electrode layer 204, and thus even if the electric active polymer layer 201 and the electrode layers 203, 204 are nontransparent, the reflective layer 205 may reflect the entering light. However, in the case of the embodiment illustrated in FIG. 6, an entering light must penetrate at least one of the first electrode layer 303 and second electrode layer 304, and the electric active polymer layer 301, and thus at least one of the first electrode layer 303 and second electrode layer 304 must be made of a transparent material, and the electric active polymer layer 303 must also be made of a transparent material. For example, in a case where the first electrode layer 303 is made of a transparent material, a light entering towards the first electrode layer 303 may penetrate the first electrode layer 303 and electric active polymer layer 301, and then be reflected by the reflective layer 305, and then the reflective light may penetrate the electric active polymer layer 301 and first electrode layer 303 again and be emitted outside the reflective varifocal lens 300. In a case where the second electrode layer 304 is made of a transparent material, a light entering towards the second electrode layer 304 may penetrate the second electrode layer 304 and electric active polymer layer 301, be reflected by the reflective layer 305, penetrate the electric active polymer layer 301 and second electrode layer 304 again, and then be emitted outside the reflective varifocal lens 300.

To embody the structure of FIG. 6, the reflective varifocal lens 300 may be configured such that the electric active polymer layer 301 has a first polymer layer and a second polymer layer, and a reflective layer 305 formed therebetween.

FIG. 7 is a plane view of a reflective varifocal lens according to another embodiment of the present disclosure, and FIG. 8 is a cross-sectional view along path B-B′ of the reflective varifocal lens of FIG. 7.

Referring to FIGS. 7 and 8, a reflective varifocal lens according to another embodiment of the present disclosure 400 includes a first electrode layer 403 having conductivity, electric active polymer layer 401 formed on the first electrode layer 403, second electrode layer 404 having conductivity formed on the electric active polymer layer 401, reflective layer 405 and support 402. In the embodiment of FIGS. 7 and 8, the electric active polymer layer 401 includes a ring-shaped first region, and a circular-shaped second region formed inside the first region. The first electrode layer 403 and second electrode layer 404 are ring-shaped, and are each formed on an upper surface and lower surface of a first region on the electric active polymer layer 401. The reflective layer 405 is circular, and is formed adjacent to the second electrode layer 404 on a lower surface of a second region on the electric active layer 401.

According to the embodiment illustrated in FIGS. 7 and 8, the reflective layer 405 is formed on a portion where light enters. In the second region that is a center of the reflective varifocal lens, only the electric active polymer layer 401 and reflective layer 405 are formed without an electrode layer, and the first electrode layer 403 and second electrode layer 404 are formed on the first region in the outskirts of the reflective layer 405. The reflective varifocal lens 400 illustrated in FIGS. 7 and 8 has a structure wherein in the reflective layer 405 portion, the electric active polymer layer 401 does not expand but only bends when a voltage is applied, and thus since the reflective layer 405 does not expand or contract together as the electric active polymer layer 401 expands, the reflective layer 405 may be made of a solid material that is not flexible.

Herein, the first electrode layer 403 may be formed on the first region just like the second electrode layer 404 as illustrated in FIG. 8, or on a region that includes both the first region and second region.

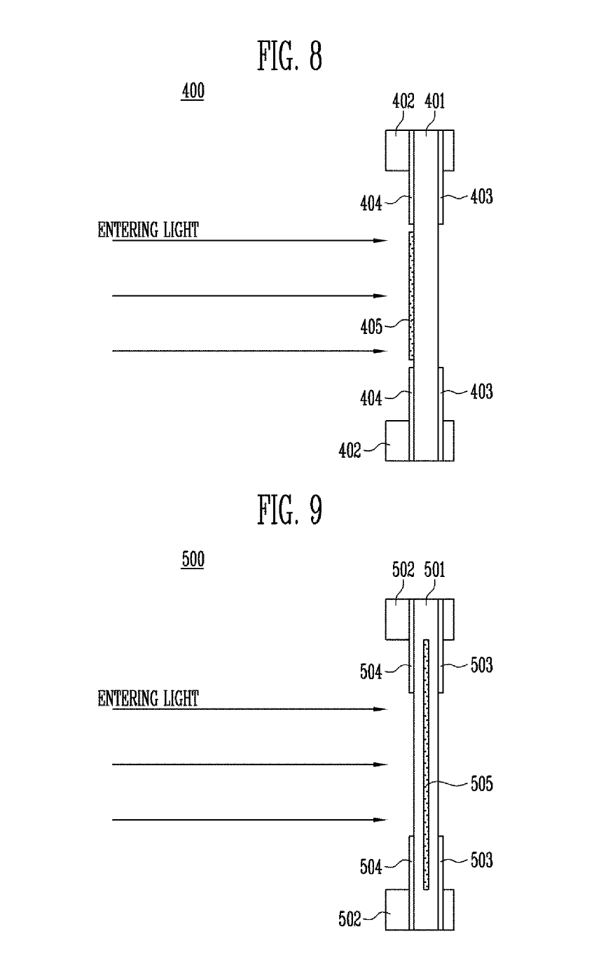

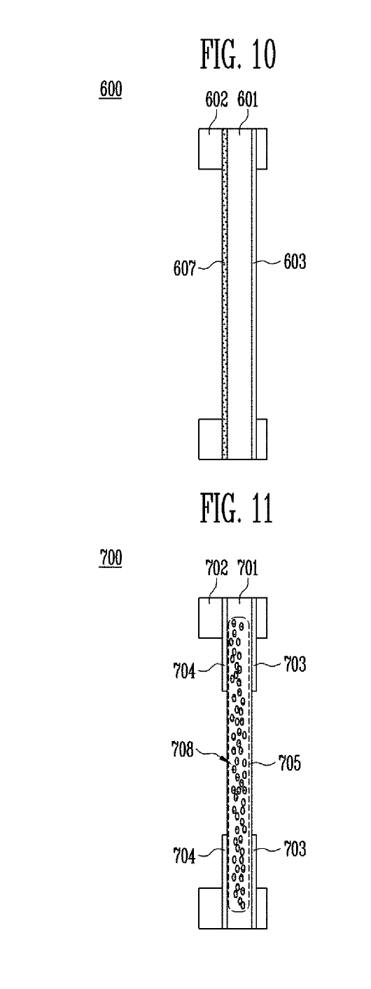

FIG. 9 is a cross-sectional view of a reflective varifocal lens according to another embodiment of the present disclosure.

Referring to FIG. 9, a reflective varifocal lens according to another embodiment of the present disclosure 500 includes a first electrode layer 503 having conductivity, electric active polymer layer 501 formed on the first electrode layer 503, second electrode layer 504 having conductivity formed on the electric active polymer layer 501, reflective layer 505 and support 502. In the embodiment of FIG. 9, the electric active polymer layer 501 includes a ring-shaped first region, and a circular-shaped second region formed within the first region. The first electrode layer 503 and second electrode layer 504 are ring-shaped, and are each formed on an upper surface and lower surface of the first region on the electric active polymer layer 501. The reflective layer 505 is circular-shaped, and is formed on the second region inside the electric active polymer layer 501. In some embodiments, the reflective layer 505 may be configured to include at least a portion of the second region and first region inside the electric active polymer layer 501. The embodiment of FIG. 9 has a structure configured to include all the advantages of the embodiment of FIG. 6 and the embodiment of FIG. 8. In the embodiment of FIG. 9, the reflective layer 505 is formed inside the electric active polymer layer 501, and the first and second electrode layers 503, 504 are formed in the outskirts of the reflective varifocal lens where light does not enter.

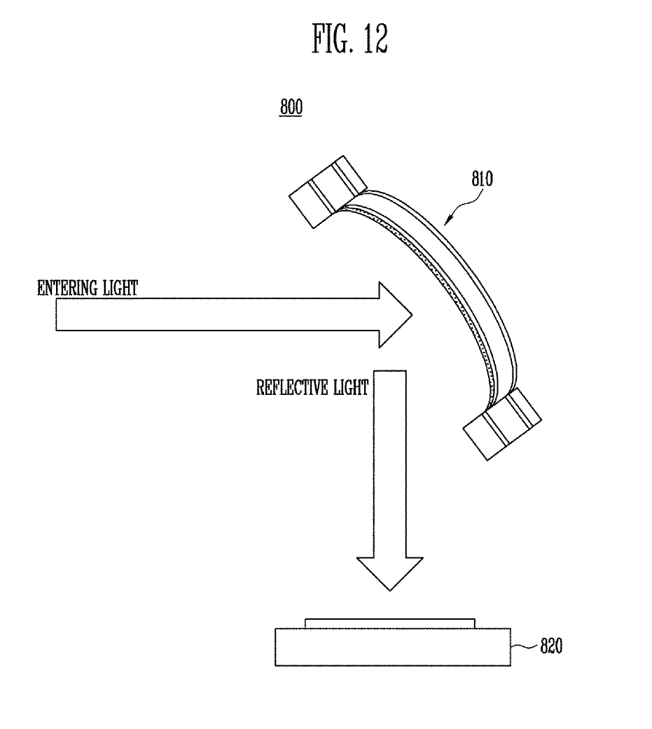

FIG. 10 is a cross-sectional view of a reflective varifocal lens according to another embodiment of the present disclosure.

Referring to FIG. 10, a reflective varifocal lens according to another embodiment of the present disclosure 600 includes a first conductive layer 603 having conductivity, electric active polymer layer 601 formed on the first electrode layer 603, second electrode layer 607 having conductivity formed on the electric active polymer layer 601, and support 602. In the embodiment of FIG. 10, the second electrode layer 607 includes a property of reflecting light. That is, in the reflective varifocal lens 600 illustrated in FIG. 10, the second electrode layer 607 plays both a role of applying an electric signal in order to change the shape of the electric active polymer layer 601 and a role of a reflective layer that reflects entering light. FIG. 10 illustrates that the second electrode layer 607 plays a role of a reflective layer, but in some embodiments, the first electrode layer 603 may play the role of a reflective layer, or else, the first electrode layer 603 and second electrode layer 607 may both play the role of a reflective layer. In a case where the need to change a focus is relatively small when actually driving a reflective varifocal lens, it is possible to form at least one of the two electrode layers with a metal thin film having excellent flexibility and light reflectivity, thereby simplifying the structure and production process.

FIG. 11 is a cross-sectional view of a reflective varifocal lens according to another embodiment of the present disclosure.

Referring to FIG. 11, a reflective varifocal lens according to another embodiment of the present disclosure 700 includes a first electrode layer 703 having conductivity, electric active polymer layer 701 formed on the first electrode layer 703, second electrode layer 704 having conductivity formed on the electric active polymer layer 701, reflective layer 705, and support 702. In the embodiment of FIG. 11, the reflective layer 705 is formed by a layer consisting of a plurality of reflective particles 708 positioned inside the electric active polymer layer 701. Therefore, the electric active polymer layer 701 may be made of a transparent material that penetrates light. In a case where the reflective layer 705 is made of the plurality of reflective particles 708 positioned inside the electric active polymer layer 701, there is no need to provide a thin film type reflective layer, and thus even when the shape of the electric active polymer layer 701 changes, there is a low probability that the reflective layer will be destructed. As illustrated in FIG. 11, the reflective layer in the reflective varifocal lens of the embodiment of the present disclosure may not necessarily be configured as a thin film, and thus it may be configured in any shape as long as it changes the focal length according to the change of shape of the electric active polymer layer.

FIG. 12 is a view illustrating an imaging system according to another embodiment of the present disclosure.

Referring to FIG. 12, an imaging system according to another embodiment of the present disclosure 800 includes a reflective varifocal lens 810 and image sensor 820. The reflective varifocal lens 810 reflects a light that enters the lens by approximately 45 degrees, and allows the reflective light to enter the image sensor 820. The reflective varifocal lens 810 includes a first electrode layer having conductivity, electric active polymer layer formed on the first electric layer, second electrode layer having conductivity formed on the electric active polymer layer, and reflective layer that reflects the light entering towards the first electrode layer or second electrode layer. Furthermore, the shape of the electric active polymer layer is changed by an electric signal being applied to the first electrode layer and second electrode layer, and as the shape of the electric active polymer layer changes, the shape of the reflective layer changes, thereby changing the focal length of the reflective light entering the image sensor 820.

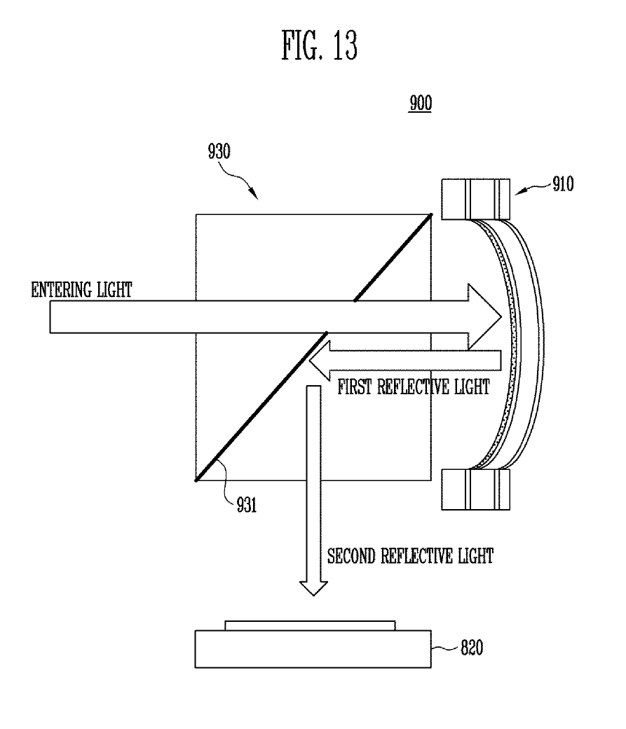

FIG. 13 is a view illustrating an imaging system according to another embodiment of the present disclosure.

Referring to FIG. 13, an image system according to another embodiment of the present disclosure 900 includes a reflective varifocal lens 910, image sensor 920, and beam splitter 930. The beam splitter 930 allows light entering the image system 900 to penetrate the beam splitter 930 and to enter the reflective varifocal lens 910. Furthermore, the beam splitter 930 reflects a first reflective light reflected from the reflective varifocal lens 910 by a reflecting surface 931 to generate a second reflective light. The second reflective light generated by the beam splitter 930 enters the image sensor 920. The reflective varifocal lens 910 includes a first electrode layer having conductivity, electric active polymer layer formed on the first electrode layer, second electrode layer having conductivity formed on the electric active polymer layer, and reflective layer that reflects the light entering towards the first electrode layer or the second electrode layer. Furthermore, the shape of the electric active polymer layer is changed by an electric signal being applied to the first electrode layer and second electrode layer of the reflective varifocal lens 910, and as the shape of the electric active polymer layer changes, the shape of the reflective layer changes, thereby changing the focal length of the first reflective light. Therefore, the focal length of the second reflective light generated by the beam splitter 930 changes as well.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A reflective varifocal lens configured to change a focal length using an electric signal, the lens comprising:
a first electrode layer having conductivity;
an electric active polymer layer formed on the first electrode layer;
a second electrode layer having conductivity formed on the electric active polymer layer; and
a reflective layer configured to reflect a light entering towards the first electrode layer or second electrode layer,
wherein a shape of the electric active polymer layer is changed by the electric signal being applied to the first electrode layer and second electrode layer, and
as the shape of the electric active polymer layer changes, a shape of the reflective layer changes, thereby changing a focal length of a reflective light.

2. The reflective varifocal lens according to claim 1,
wherein the reflective layer is formed on a lower surface of the first electrode layer or an upper surface of the second electrode layer.

3. The reflective varifocal lens according to claim 1,
wherein the reflective layer is formed within the electric active polymer layer.

4. The reflective varifocal lens according to claim 3,
wherein at least one of the first electrode layer and second electrode layer, and the electric active polymer layer are made of transparent material.

5. The reflective varifocal lens according to claim 3,
wherein the electric active polymer layer comprises a first polymer layer and second polymer layer, and the reflective layer is disposed between the first polymer layer and second polymer layer.

6. The reflective varifocal lens according to claim 1,
wherein the electric active polymer layer comprises a ring-shaped first region and a circular-shaped second region inside the first region,
the first electrode layer and second electrode layer are ring-shaped, and are formed on a lower surface and upper surface of the first region of the electric active polymer layer, and
the reflective layer is circular-shaped, and is formed on an upper surface or lower surface of the second region of the electric active polymer layer.

7. The reflective varifocal lens according to claim 1,
wherein the electric active polymer layer comprises a ring-shaped first region and a circular-shaped second region inside the first region,
the first electrode layer and second electrode layer are ring-shaped, and are formed on a lower surface and upper surface of the first region of the electric active polymer layer,
the reflective layer is circular-shaped, and is formed on the second region inside the electric active polymer layer, and
the electric active polymer layer is made of transparent material.

8. The reflective varifocal lens according to claim 1,
wherein the reflective layer is formed by a plurality of reflective particle layers positioned inside the electric active polymer layer.

9. A reflective varifocal lens comprising:
a first conductive layer having conductivity;
an electric active polymer layer formed on the first electrode layer; and
a second electrode layer having conductivity formed on the electric active polymer layer,
wherein at least one of the first electrode layer and second electrode layer is configured to reflect light,
a shape of the electric active polymer layer is changed by an electric signal being applied to the first electrode layer and second electrode layer, and
as the shape of the electric active polymer layer changes, a shape of the at least one of the first electrode layer and second electrode layer configured to reflect light changes, thereby changing a focal length of a reflective light.

10. An image system comprising:
an image sensor; and
a reflective varifocal lens configured to reflect an entering light and allow the same to enter the image sensor,
wherein the reflective varifocal lens comprises:
a first electrode layer having conductivity;
an electric active polymer layer formed on the first electrode layer;
a second electrode layer having conductivity formed on the electric active polymer layer; and
a reflective layer configured to reflect a light entering towards the first electrode layer or second electrode layer, and
a shape of the electric active polymer layer is changed by an electric signal being applied to the first electrode layer and second electrode layer, and
as a shape of the electric active polymer layer changes, a shape of the reflective layer changes, thereby changing a focal length of a reflective light entering the image sensor.

11. The image system according to claim 10,
further comprising a beam splitter,
wherein the beam splitter is configured to allow a light entering the image system to penetrate the beam splitter and enter the reflective varifocal lens, and to change a proceeding direction of the light reflected from the reflective varifocal lens so that the reflective light enters the image sensor.
